(19) United States
(12) Patent Application Publication
(10) Pub. No.: US 2008/0320033 A1
(43) Pub. Date: Dec. 25, 2008

(54) Method, Apparatus and Computer Program Product for Providing Association of Objects Using Metadata

(75) Inventors: Kirmo Kalevi Koistinen, Oulu (FI); Kari Pentti Ilari Kaarela, Oulu (FI); Jukka Antero Parkkinen, Oulu (FI); Timo Pekka Tervo, Oulu (FI); Heikki Veikko Juhani Korkeamaki, Oulu (FI); Mikko Antti Juhani Hyvarinen, Oulu (FI); Jari Jaakko Sauvola, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/766,311

(22) Filed: Jun. 21, 2007

(51) Int. Cl. G06F 17/30

(52) U.S. Cl. 707/103 R; 707/E17.031

(57) ABSTRACT

An apparatus for providing association of objects using metadata may include a processing element. The processing element may be configured to extract metadata associated with an object, form, based on a predefined rule set and in response to an event, an associative relationship between the object and at least one other object associated with a same application as the object or a different application than the object based on the extracted metadata, and perform a function based on the associative relationship.

### TECHNOLOGICAL FIELD

Embodiments of the present invention relate generally to content management technology and, more particularly, relate to a method, device, mobile terminal and computer program product for associating content or objects using metadata subsets.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to store content, and given also that mobile electronic devices such as mobile phones often face limitations in display size, text input speed, and physical embodiments of user interfaces (UI), challenges are created in content management. Specifically, an imbalance between the development of stored content capabilities and the development of physical UI capabilities may be perceived.

In order to provide a solution for the imbalance described above, metadata and other content management enhancements have been developed. Metadata typically includes information that is separate from an object, but related to the object. An object may be “tagged” by adding metadata to the object. As such, metadata may be used to specify properties associated with the object that may not be obvious from the object itself. Metadata may then be used to organize the objects to improve content management capabilities.

Currently, devices such as mobile terminals are becoming more and more adept at content creation (e.g., images, videos, product descriptions, event descriptions, etc.). However, tagging of objects produced as a result of content creation is typically a challenge given the limited physical UI capabilities of mobile terminals. For example, it may be cumbersome to type in a new metadata entry for each content item created. Accordingly, although tagging objects with metadata improves content management capabilities, the efficiency of tagging may become a limiting factor.

Additionally, some methods have been developed for inserting metadata based on context. Context metadata describes the context in which a particular content item was “created”. Hereinafter, the term “created” should be understood to be defined such as to encompass also the terms captured, received, and downloaded. In other words, content is defined as “created” whenever the content first becomes resident in a device, by whatever means regardless of whether the content previously existed on other devices. Context metadata can be associated with each content item in order to provide an annotation to facilitate efficient content management features such as searching and organization features. Accordingly, the context metadata may be used to provide an automated mechanism by which content management may be enhanced and user efforts may be minimized. However, context metadata and other types of metadata may be standardized dependent upon factors such as context. Thus, tagging of content items that may have, for example, more than one context may become complicated. Furthermore, a user typically has limited control over the context and therefore limited control over tagging of content items according to the user's desires since automated context tagging may be performed in a manner specific to a particular application.

Although the metadata may then be used as a basis for searching for content, due to the varieties of metadata that may be assigned by different users or different applications, it may be difficult to locate content that is otherwise related to a particular root object. Moreover, it may be difficult to associate previously existing content with a particular root object due to a lack of or inconsistencies in the corresponding metadata.

Thus, it may be advantageous to provide an improved method of associating metadata or tags with content items that are created, which may provide improved content searching and/or organization.

### BRIEF SUMMARY

A method, apparatus and computer program product are therefore provided to enable association of objects by linking events with associated metadata. In particular, a method, apparatus and computer program product are provided that provide for the formation of subsets of associated metadata. In an exemplary embodiment, the subsets of associated metadata may be formed by the utilization of a predefined rule set. In this regard, the formation of the subsets of associated metadata may be automatically employed. Thus, objects created in any of various applications may be associated with other objects or content that are linked through a corresponding event or characteristic. Moreover, existing metadata may be recaptured for meaningful use in searching, viewing, organizing, and/or presenting information. Accordingly, the efficiency and universality of metadata usage may be increased and content management for devices such as mobile terminals may be improved.

In one exemplary embodiment, a method of providing metadata association is provided. The method includes extracting metadata associated with an object, forming, based on a predefined rule set and in response to an event, an associative relationship between the object and at least one other object associated with a same application as the object or a different application than the object based on the extracted metadata, and performing a function based on the associative relationship.

In another exemplary embodiment, a computer program product for providing metadata association is provided. The computer program product includes at least one computer-readable storage medium having computer-readable program code portions stored therein. The computer-readable program code portions include first, second and third executable portions. The first executable portion is for extracting metadata associated with an object. The second executable portion is for forming, based on a predefined rule set and in response to an event, an associative relationship between the object and at least one other object associated with a same application as the object or a different application than the object based on the extracted metadata. The third executable portion is for performing a function based on the associative relationship.

In another exemplary embodiment, an apparatus for providing metadata association is provided. The apparatus may include a processing element. The processing element may be configured to extract metadata associated with an object, form, based on a predefined rule set and in response to an event, an associative relationship between the object and at least one other object associated with a same application as the object or a different application than the object based on the extracted metadata, and perform a function based on the associative relationship.

In another exemplary embodiment, an apparatus for providing metadata association is provided. The apparatus includes means for extracting metadata associated with an object, means for forming, based on a predefined rule set and in response to an event, an associative relationship between the object and at least one other object associated with a same application as the object or a different application than the object based on the extracted metadata, and means for performing a function based on the associative relationship.

Embodiments of the invention may provide a method, apparatus and computer program product for advantageous employment in a mobile electronic device environment, such as on a mobile terminal capable of creating content items and objects related to various types of media. As a result, for example, mobile terminal users may enjoy an improved content management capability.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing association of objects using metadata according to an exemplary embodiment of the present invention; and

FIG. 4 is a flowchart according to an exemplary method for providing association of objects using metadata according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

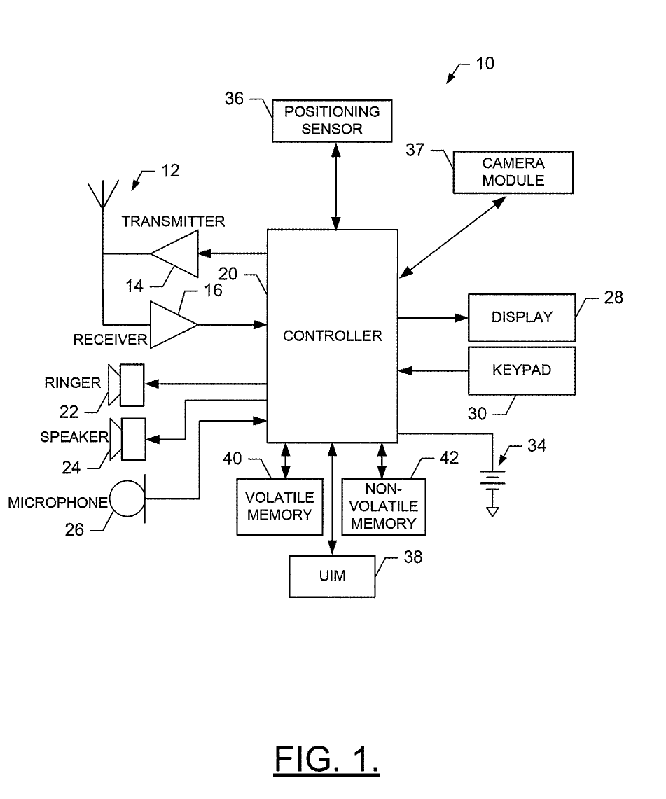

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 includes all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to a JPEG standard format.

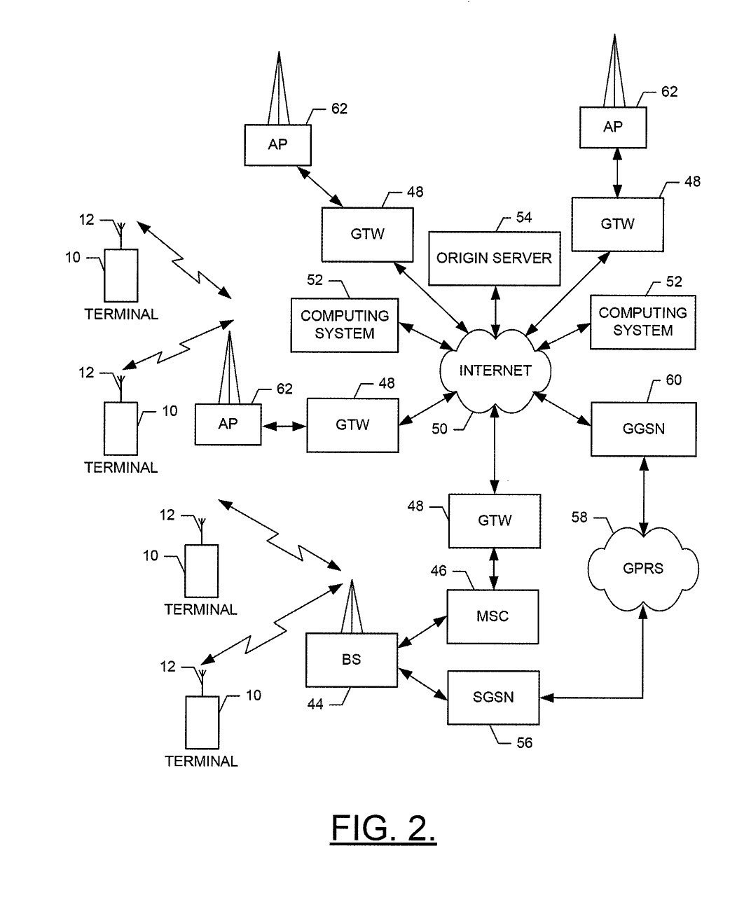

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

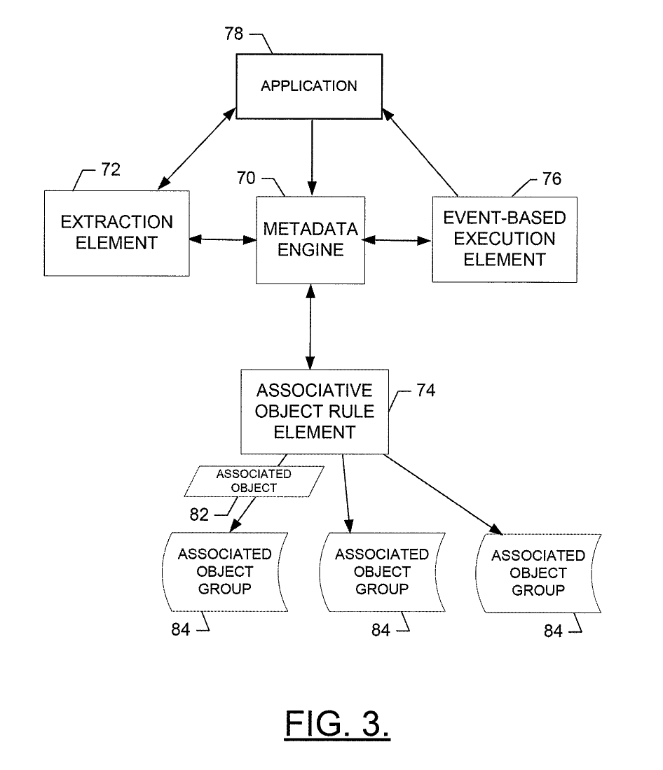

An exemplary embodiment of the invention will now be described with reference to FIG. 3, in which certain elements of a system for providing association of metadata are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. For example, the system of FIG. 3 may be employed on a personal computer, a camera, a video recorder, etc. Alternatively, embodiments may be employed on a combination of devices including, for example, those listed above. It should also be noted, however, that while FIG. 3 illustrates one example of a configuration of a system for providing content tagging for use, for example, in metadata-based content management, numerous other configurations may also be used to implement embodiments of the present invention.

Referring now to FIG. 3, a system for providing association of objects using metadata is provided. The system may be embodied in hardware, software or a combination of hardware and software for use by a device such as the mobile terminal. The system may include a metadata engine 70, an extraction element 72, and an associative object rule element 74. In an exemplary embodiment, the system may also include an event-based execution element 76. One or more of the metadata engine 70, the extraction element 72, the associative object rule element 74 and the event-based execution element 76 may be in communication with an application 78 being executed, for example, by a processing element of the device employing the system (e.g., the controller 20). In an exemplary embodiment, the application 78 may be in communication with at least the metadata engine 70 to enable the metadata engine 70 to generate metadata for content created in response to execution of the application 78. For example, the application 78 may import a file, capture an image or video sequence, download a web page, generate a document, etc., to create an object which may include any type of content and the metadata engine 70 may assign metadata to the created object for storage in association with the created object. In an exemplary embodiment, the metadata engine 70 may be in simultaneous communication with a plurality of applications and may generate metadata for each corresponding application. Examples of applications that may be in communication with the metadata engine 70 may include without limitation phonebook, document creation, calendar, gallery, messaging client, location client, calculator and other like applications.

Each of the metadata engine 70, the extraction element 72, the associative object rule element 74 and the event-based execution element 76 may be embodied as any device or means embodied in either hardware, software, or a combination of hardware and software that is capable of performing the corresponding functions of the metadata engine 70, the extraction element 72, the associative object rule element 74 and the event-based execution element 76, respectively, as described in greater detail below. As such, the metadata engine 70, the extraction element 72, the associative object rule element 74 and the event-based execution element 76 may each be controlled by or otherwise embodied as the processing element (e.g., the controller 20). Processing elements such as those described herein may be embodied in many ways. For example, the processing element may be embodied as a processor, a coprocessor, a controller or various other processing means or devices including integrated circuits such as, for example, an ASIC (application specific integrated circuit).

It should be noted that any or all of the metadata engine 70, the extraction element 72, the associative object rule element 74 and the event-based execution element 76 may be collocated in a single device. For example, the mobile terminal 10 of FIG. 1 may include all of the metadata engine 70, the extraction element 72, the associative object rule element 74 and the event-based execution element 76. Alternatively, any or all of the metadata engine 70, the extraction element 72, the associative object rule element 74 and the event-based execution element 76 may be disposed in different devices. For example, one or more of the metadata engine 70, the extraction element 72, the associative object rule element 74 and the event-based execution element 76 may be disposed at a server or remote display, while others are disposed at a mobile terminal in communication with the server or remote display.

The extraction element 72 may be any device or means embodied in either hardware, software, or a combination of hardware and software configured to extract event and/or metadata related information from objects associated with the application 78. In this regard, for example, if an event is detected at the extraction element 72 such as creation of an image or other visual media (e.g., by taking a picture with the camera module 37), the extraction element 72 may communicate the event information to the metadata engine 70 for assignment of metadata to the object associated with the event information. As an alternative (or as an additional feature), the extraction element 72 may be configure to extract metadata from existing content or objects or newly acquired content or objects. Thus, for example, if an embodiment of the present invention is installed on an existing device, the extraction element 72 may extract metadata from the stored content of the device for association of the content as described below. Alternatively, if a device practicing an embodiment of the present invention is placed in communication with a memory having content or objects stored therein that were not associated via their corresponding metadata, the extraction element 72 may extract metadata from the content or objects stored therein for association of the content or objects in accordance with embodiments of the invention. As such, the extraction element 72 may be configured to make recollections of earlier events. In any case, event and/or metadata information extracted by the extraction element 72 may be communicated to the metadata engine 70.

In an exemplary embodiment, the metadata engine 70 may be any device or means embodied in either hardware, software, or a combination of hardware and software configured to generate metadata according to a defined set of rules. The defined set of rules may proscribe, for example, the metadata that should be assigned to content created using one or more of the applications. In response to receipt of event and/or metadata information from the extraction element 72, the metadata engine 70 may be configured to communicate such received information to the associative object rule element 74.

The associative object rule element 74 may be any device or means embodied in either hardware, software, or a combination of hardware and software configured to determine if the event and/or metadata information is associated with a predefined rule set stored at the associative object rule element 74. In an exemplary embodiment, the associative object rule element 74 may be configured to consider whether to make associations as described below in response to the occurrence or detection of an event (e.g., a mobile phone event). As such, for example, in response to an event, if the event and/or metadata information are associated with a rule of the predefined rule set, the associative object rule element 74 may be configured to define the corresponding object as an associated object 82 by adding the corresponding object to a predefined associated object group 84. Each predefined associated object group 84 may be a subset of objects that are related via metadata and/or event information. Thus, for example, a subset of objects may be related or associated with each other by virtue of sharing a particular characteristic or event such as being created on a given day, during a particular calendar event, in a particular location, at a particular time, in the presence of a particular individual, including a particular person or item, etc., any of which may be stored in association with each of the subset of objects as metadata that may have been, for example, extracted by the extraction element 72 or inserted by the metadata engine 70. In an exemplary embodiment, each associated object could be stored in a folder embodying the predefined associated object group 84. However, alternatively, data identifying each object associated with a predefined associated object group 84 may be stored.

As a more specific example, a calendar application may specify a calendar event of a weeklong vacation. All content or objects created during the vacation may be defined by the associative object rule element 74 as associated objects with regard to each other on the basis of the shared event between such created content or objects (i.e., occurrence during the vacation). In other words, the associative object rule element 74 may include a rule to associate all content created during a particular time period (e.g., the time period designated to correspond to the vacation) as associated objects under a root term of “vacation”. Furthermore, if one particular portion of the vacation was spent in Paris, the associative object rule element 74 may be configured to utilize location information (e.g., context metadata or location history) as the basis for associating content items created in Paris. Accordingly, if a root metadata object of “Vacation” were selected, all associated objects of the predefined associated object group sharing metadata or event information associated with the vacation (e.g., all objects created during the period that the calendar application designated as corresponding to the vacation) may be displayed. Meanwhile, in response to selection of a root metadata object of “Paris”, a subset of the vacation related objects (e.g., those objects created at the location corresponding to Paris) may be displayed.

According to exemplary embodiments of the present invention, the device employing the system may include an ontology describing all object types for applications on the device. Accordingly, a predefined metadata schema defined according to the ontology may be utilized for enabling integration of objects created using any of the applications. The associative object rule element 74 may be configured to use the predefined metadata schema in connection with associating objects as associated objects by assigning such objects to metadata subgroups (e.g., an associated object group 84) based on the predefined rule sets.

The predefined rule sets may include at least a root object definition and a limit for the associated object. The root object definition may be determined at least in part by the ontology employed by the system. In an exemplary embodiment, the root object definition may be a contact object and the limit may be a timeline value. In other words, for example, every contact object may be defined to be associated in an associated object group 84 if such contact object includes an event and/or metadata object that occurred or was created during a defined timeframe corresponding to the timeline value. As described above, the timeline value could be defined for particular calendar events.

Accordingly, based on the information above, embodiments of the present invention may provide for data extraction related to created objects. The extracted data which may include metadata and/or event information may then be used to define associated objects on the basis of a predefined rule set. In this regard, the metadata may include event information. The associated objects may be objects that are associated with each other on the basis of sharing a characteristic or event as indicated by the corresponding metadata. The associated objects may then be stored as or otherwise associated with a corresponding predefined group (e.g., an associated object group), which may be a metadata subgroup according to some embodiments. By associating objects into associated object groups, functions may be more easily performed with regard to the objects. For example, associated objects may be used to generate new view models for existing core applications of the mobile terminal 10. As an example, a gallery may produce a new type of view automatically such that images can be sorted based on time, location, persons in an image, etc. As another example, an inbox may create a new view of messages based on a person or collection of persons such as colleagues, or based on time. Such functionality may be performed by the processing element of the mobile terminal or other device employing embodiments of the present invention.

As stated above, an exemplary embodiment may include the event-based execution element 76. The event-based execution element 76 may be any device or means embodied in either hardware, software, or a combination of hardware and software configured to interact with the application 78 in order to define application actions based on event and/or history data. In this regard, for example, the event-based execution element 76 may be configured to create automatic notes based on collected metadata information. An example of automatic note taking may include creating a document, such as a log, that records and/or includes all events and/or objects performed during a particular timeline period or event. For example, if a calendar event is provided to cover a particular time period, any events occurring and/or objects created may be logged during the meeting. Accordingly, a single document (e.g., a meeting log) may be viewed as a root object and all associated events and/or objects that were logged in connection with the meeting may be viewed, for example, in timeline order.

The event-based execution element 76 may also or alternatively be configured to enable the mobile terminal 10 (or whatever device employs embodiments of the present invention) to perform automatic actions based on historical data. In this regard, a record of events may be stored (e.g., such as via the logging function above) which may record a series of events and an action taken or result of the series of events. A rule may be determined with regard to the series of events, for example, in response to a predetermined number of occurrences of the series of events in which the same action taken or result occurs. Accordingly, in response to the event-based execution element 76 determining that the series of events has currently occurred, the event-based execution element 76 may invoke the rule to instruct the application 78 or the mobile terminal 10 to take the corresponding action or achieve the corresponding result proscribed according to the rule. As an example, if a user sets the profile of the mobile terminal 10 to “work” when the user arrives at work, the event-based execution element 76 may recognize, after a predetermined number of occurrences of the series of events defined by a location application determining arrival at the user's work and subsequent changing of the profile, that once the arrival of the user at work is determined by the location application, the profile should automatically be changed to “work”. Time or other considerations and/or actions may also be considered in addition to or instead of location criteria.

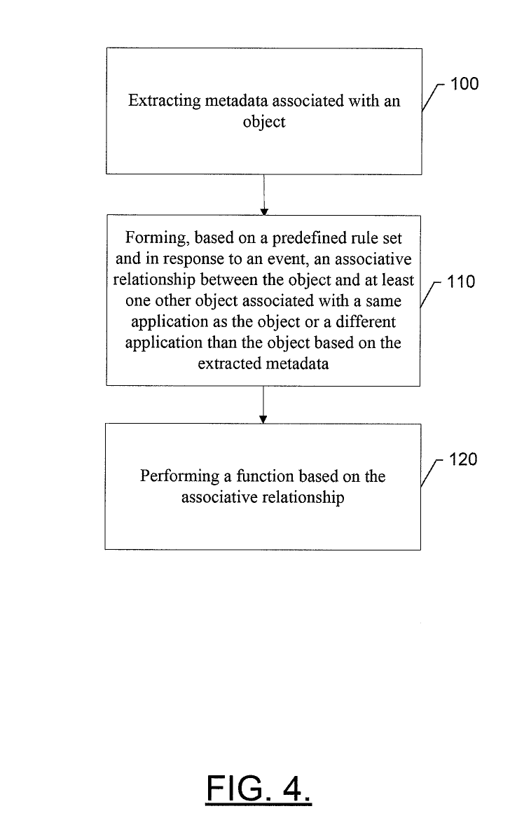

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing association of objects using metadata may include extracting metadata associated with an object at operation 100. The extraction of the metadata may be performed in response to creation of the object or on previously existing objects. At operation 110, an associative relationship may be formed between the object and at least one other object associated with a same application as the object or a different application than the object based on the extracted metadata and in response to an event. The associative relationship may be formed based on a predefined rule set. In an exemplary embodiment, updates may be received for the predefined rule set. In other words, the rule set may be dynamically changed to thereby change the association creation rules. This may be done automatically (e.g., based on context) or when a new application having new rules is installed. In an exemplary embodiment, forming the associative relationship may include defining the object and the at least one other object to be members of a predefined associated object group. In another exemplary embodiment, forming the associative relation ship may include associating objects created with timeline events associated with the different processes or applications. A function may be performed based on the associative relationship at operation 120.

In an exemplary embodiment, the function performed may include, for example, preparing a log of events associated with a root entry, returning search results for a selected root object, generating a user interface based on a selected root object, or automatically generating a view of content based on a selected root object. In another exemplary embodiment, the method may include an optional operation of recognizing a current series of events corresponding to a similar recorded series of events. In such a case, the function performed may include executing a predefined functionality to achieve a current result determined based on a result of the similar recorded series of events.

It should be noted that although exemplary embodiments discuss objects or content items, such objects may be, without limitation, image related content items, video files, television broadcast data, text, web pages, web links, audio files, radio broadcast data, broadcast programming guide data, location tracklog, etc. Additionally, it should be understood that, according to an exemplary embodiment, events as referred to herein may correspond to any event possible in a mobile phone. In this regard, in addition to events related to content creation, other events such as answering or placing a call, sending or receiving an SMS, establishing or terminating a communication session (e.g., VoIP, PTT, etc.) and other like events may all be within the scope of embodiments of the present invention. As such, for example, events such as those described above may be used in defining the “IF” portion related to predefined rules, such as XML rules, for defining what associations are to be created in response to an event.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
extracting metadata associated with an object;
forming, based on a predefined rule set and in response to an event, an associative relationship between the object and at least one other object associated with a same application as the object or a different application than the object, based on the extracted metadata; and
performing a function based on the associative relationship.

2. A method according to claim 1, wherein forming the associative relationship comprises defining the object and the at least one other object to be members of a predefined associated object group.

3. A method according to claim 1, wherein extracting metadata comprises acquiring metadata associated with the object in response to creation of the object.

4. A method according to claim 1, wherein extracting metadata comprises extracting metadata associated with a previously existing object.

5. A method according to claim 1, wherein performing the function comprises preparing a log of events associated with a root entry.

6. A method according to claim 1, wherein performing the function comprises returning search results for a selected root object.

7. A method according to claim 1, further comprising recognizing a current series of events corresponding to a similar recorded series of events, and wherein performing the function comprises executing a predefined functionality to achieve a current result determined based on a result of the similar recorded series of events.

8. A method according to claim 1, wherein performing the function comprises generating a user interface based on a selected root object.

9. A method according to claim 1, wherein performing the function comprises automatically generating a view of content based on a selected root object.

10. A method according to claim 1, wherein forming the associative relationship comprises associating objects created with timeline events associated with different processes.

11. A method according to claim 1, wherein forming the associative relationship in response to the event comprises forming the associative relationship in response to an event at a mobile terminal.

12. A method according to claim 1, further comprising receiving an update of the predefined rule set.

13. A computer program product comprising at least one computer-readable storage medium having computer-readable program code portions stored therein, the computer-readable program code portions comprising:
a first executable portion for extracting metadata associated with an object;
a second executable portion for forming, based on a predefined rule set and in response to an event, an associative relationship between the object and at least one other object associated with a same application as the object or a different application than the object based on the extracted metadata; and
a third executable portion for performing a function based on the associative relationship.

14. A computer program product according to claim 13, wherein the second executable portion includes instructions for defining the object and the at least one other object to be members of a predefined associated object group.

15. A computer program product according to claim 13, wherein the first executable portion includes instructions for acquiring metadata associated with the object in response to creation of the object.

16. A computer program product according to claim 13, wherein the first executable portion includes instructions for extracting metadata associated with a previously existing object.

17. A computer program product according to claim 13, wherein the third executable portion includes instructions for preparing a log of events associated with a root entry.

18. A computer program product according to claim 13, wherein the third executable portion includes instructions for returning search results for a selected root object.

19. A computer program product according to claim 13, further comprising a fourth executable portion for recognizing a current series of events corresponding to a similar recorded series of events, and wherein the third executable portion includes instructions for executing a predefined functionality to achieve a current result determined based on a result of the similar recorded series of events.

20. A computer program product according to claim 13, wherein the third executable portion includes instructions for generating a user interface based on a selected root object.

21. A computer program product according to claim 13, wherein the third executable portion includes instructions for automatically generating a view of content based on a selected root object.

22. A computer program product according to claim 13, wherein the second executable portion includes instructions for associating objects created with timeline events associated with different processes.

23. A computer program product according to claim 13, wherein the second executable portion includes instructions for forming the associative relationship in response to an event at a mobile terminal.

24. A computer program product according to claim 13, further comprising a fourth executable portion for receiving an update of the predefined rule set.

25. An apparatus comprising a processing element configured to:
extract metadata associated with an object;
form, based on a predefined rule set and in response to an event, an associative relationship between the object and at least one other object associated with a same application as the object or a different application than the object based on the extracted metadata; and
perform a function based on the associative relationship.

26. An apparatus according to claim 25, wherein the processing element is further configured to define the object and the at least one other object to be members of a predefined associated object group.

27. An apparatus according to claim 25, wherein the processing element is further configured to acquire metadata associated with the object in response to creation of the object.

28. An apparatus according to claim 25, wherein the processing element is further configured to extract metadata associated with a previously existing object.

29. An apparatus according to claim 25, wherein the processing element is further configured to prepare a log of events associated with a root entry.

30. An apparatus according to claim 25, wherein the processing element is further configured to return search results for a selected root object.

31. An apparatus according to claim 25, wherein the processing element is further configured to recognize a current series of events corresponding to a similar recorded series of events, and to execute a predefined functionality to achieve a current result determined based on a result of the similar recorded series of events.

32. An apparatus according to claim 25, wherein the processing element is further configured to generate a user interface based on a selected root object.

33. An apparatus according to claim 25, wherein the processing element is further configured to automatically generate a view of content based on a selected root object.

34. An apparatus according to claim 25, wherein the processing element is further configured to associate objects created with timeline events associated with different processes.

35. An apparatus according to claim 25, wherein the processing element is further configured to form the associative relationship in response to an event at a mobile terminal.

36. An apparatus according to claim 25, wherein the processing element is further configured to receive an update of the predefined rule set.

37. An apparatus comprising:
means for extracting metadata associated with an object;
means for forming, based on a predefined rule set and in response to an event, an associative relationship between the object and at least one other object associated with a same application as the object or a different application than the object, based on the extracted metadata; and
means for performing a function based on the associative relationship.

38. An apparatus according to claim 31, wherein means for forming the associative relationship further comprises means for defining the object and the at least one other object to be members of a predefined associated object group.
